(19) United States
(12) Patent Application Publication
(10) Pub. No.: US 2011/0293004 A1
(43) Pub. Date: Dec. 1, 2011

(54) METHOD FOR PROCESSING MOTION PARTITIONS IN TREE-BASED MOTION COMPENSATION AND RELATED BINARIZATION PROCESSING CIRCUIT THEREOF

(76) Inventors: Jicheng An, Beijing City (CN); Ching-Yeh Chen, Taipei City (TW); Yu-Wen Huang, Taipei City (TW); Xun Guo, Beijing City (CN)

(21) Appl. No.: 13/007,991

(22) Filed: Jan. 17, 2011

Related U.S. Application Data
(60) Provisional application No. 61/348,315, filed on May 26, 2010.

(51) Int. Cl. H04N 7/26

(52) U.S. Cl. 375/240.13; 375/E07.105

(57) ABSTRACT

A method for processing a target motion partition in a tree-based motion compensation includes utilizing a setting unit for providing a first binarization rule which defines a plurality of binarization codewords mapped to a plurality of syntax elements for different motion partitions, respectively, wherein a codeword length of a binarization codeword corresponding to any square inter-prediction motion partition is shorter than a codeword length of a binarization codeword corresponding to any non-square inter-prediction motion partition; and identifying mapping between a target binarization codeword and a target syntax element of the target motion partition according to the first binarization rule.

### CROSS REFERENCE TO RELATED APPLICATIONS

This application claims the benefit of U.S. provisional application No. 61/348,315, filed on May 26, 2010 and incorporated herein by reference.

### BACKGROUND

The disclosed embodiments of the present invention relate to video coding, and more particularly, to a method for processing motion partitions in a tree-based motion compensation and related binarization processing circuit thereof.

A coding unit (CU) is defined as a basic unit which has a square shape. Many processing steps are performed on the CU basis, including intra/inter prediction, transform, quantization, entropy coding, etc. Two special terms are defined: the largest coding unit (LCU) and the smallest coding unit (SCU). For convenient implementation, each of an LCU size and an SCU size is limited to value which is a power of 2 and greater than or equal to 8. Since the CU is restricted to be a square shape, the CU structure within an LCU can be expressed in a recursive tree representation adapted to the picture. That is, one CU may be characterized by an LCU size and a hierarchical depth in the LCU that the CU belongs to. In other words, one CU can be split into multiple smaller CUs. For example, a 16×16 CU may be split into four 8×8 CUs. The sizes of LCU and SCU are specified by information such as a LCU size value s and a maximum hierarchical depth value h in an LCU. For example, if s=128 and h=5, 5 kinds of CU sizes are possible: 128×128 (LCU), 64×64, 32×32, 16×16 and 8×8 (SCU). If s=16 and h=2, 2 kinds of CU sizes are possible: 16×16 (LCU) and 8×8 (SCU). Therefore, if the LCU size value and the maximum hierarchical depth value are given, possible CU sizes are defined correspondingly.

A CU may have one or more prediction units (PUs), however. Pixels of a PU share the same motion information (e.g., prediction direction, reference picture index, and motion vector) or intra prediction mode. In H.264, when CU=16×16, intra-prediction PU may be 16×16, or 8×8, or 4×4, and inter-prediction PU may be 16×16, or 16×8, or 8×16; and when CU=8×8, no intra-prediction PU is allowed, and inter-prediction PU may be 8×8, or 8×4, or 4×8, or 4×4. In the extended macroblock proposal, when CU=64×64, no intra-prediction PU is allowed, and inter-prediction PU may be 64×64, or 64×32, or 32×64; when CU=32×32, no intra-prediction PU is allowed, and inter-prediction PU may be 32×32, or 32×16, or 16×32; when CU=16×16, intra-prediction PU may be 16×16, or 8×8, or 4×4, and inter-prediction PU may be 16×16, or 16×8, or 8×16; and when CU=8×8, no intra-prediction PU is allowed, and inter-prediction PU may be 8×8, or 8×4, or 4×8, or 4×4. In H.265/High Efficiency Video Coding (HEVC) Test Model under Consideration (TMuC), there are two intra-prediction PU options and nine inter-prediction PU options for each CU.

Regarding a tree-based motion compensation, binarization representation for macroblock type (mb_type) in B slices is used in the context-adaptive binary arithmetic coding (CABAC). Please refer to FIG. 1, which is a diagram illustrating a conventional binarization table of mb_type for a 16×16 motion partition (e.g., CU=16×16). As can be seen from FIG. 1, the square inter-prediction motion partition B_{—}8×8, indexed by 22, has a codeword (i.e., a bin string) assigned with “111101”, whereas the other square inter-prediction motion partitions B_Direct_{—}16×16, B_L0_{—}16×16, B_L1_{—}16×16, and B_Bi_{—}16×16, respectively indexed by 0, 1, 2, and 3, have codewords respectively assigned with “0”, “100”, 101″ and “110000”. As the rectangular (non-square) inter-prediction motion partitions generally have low occurrence probabilities, such a codeword assignment may not achieve optimized Rate-Distortion (RD) performance.

### SUMMARY

In accordance with exemplary embodiments of the present invention, a method for processing motion partitions in the tree-based motion compensation and related binarization processing circuit thereof are proposed to improve RD performance.

According to a first aspect of the present invention, an exemplary method for processing a target motion partition in a tree-based motion compensation is disclosed. The exemplary method includes: utilizing a setting unit for providing a first binarization rule which defines a plurality of binarization codewords mapped to a plurality of syntax elements for different motion partitions, respectively, wherein a codeword length of a binarization codeword corresponding to any square inter-prediction motion partition is shorter than a codeword length of a binarization codeword corresponding to any non-square inter-prediction motion partition; and identifying mapping between a target binarization codeword and a target syntax element of the target motion partition according to the first binarization rule.

According to a second aspect of the present invention, an exemplary binarization processing circuit for processing a target motion partition in a tree-based motion compensation is disclosed. The exemplary binarization processing circuit includes a setting unit and a processing unit. The setting unit is arranged to provide a first binarization rule which defines a plurality of binarization codewords mapped to a plurality of syntax elements for different motion partitions, respectively, wherein a codeword length of a binarization codeword corresponding to any square inter-prediction motion partition is shorter than a codeword length of a binarization codeword corresponding to any non-square inter-prediction motion partition. The processing unit is coupled to the setting unit, and used for identifying mapping between a target binarization codeword and a target syntax element of the target motion partition according to the first binarization rule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional binarization table of macroblock type for a 16×16 motion partition.

FIG. 2 is a diagram illustrating a coding system according to a first exemplary embodiment of the present invention.

FIG. 3 is a diagram illustrating an exemplary embodiment of a modified binarization table of macroblock type for a 16×16 motion partition according to the present invention.

FIG. 4 is a flowchart illustrating a method for processing a target motion partition in a tree-based motion compensation according to a first exemplary embodiment of the present invention.

FIG. 5 is a diagram illustrating a coding system according to a second exemplary embodiment of the present invention.

FIG. 6 is a flowchart illustrating a method for processing a target motion partition in a tree-based motion compensation according to a second exemplary embodiment of the present invention.

FIG. 7 is a diagram illustrating a coding system according to a third exemplary embodiment of the present invention.

FIG. 8 is a flowchart illustrating a method for processing a target motion partition in a tree-based motion compensation according to a third exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

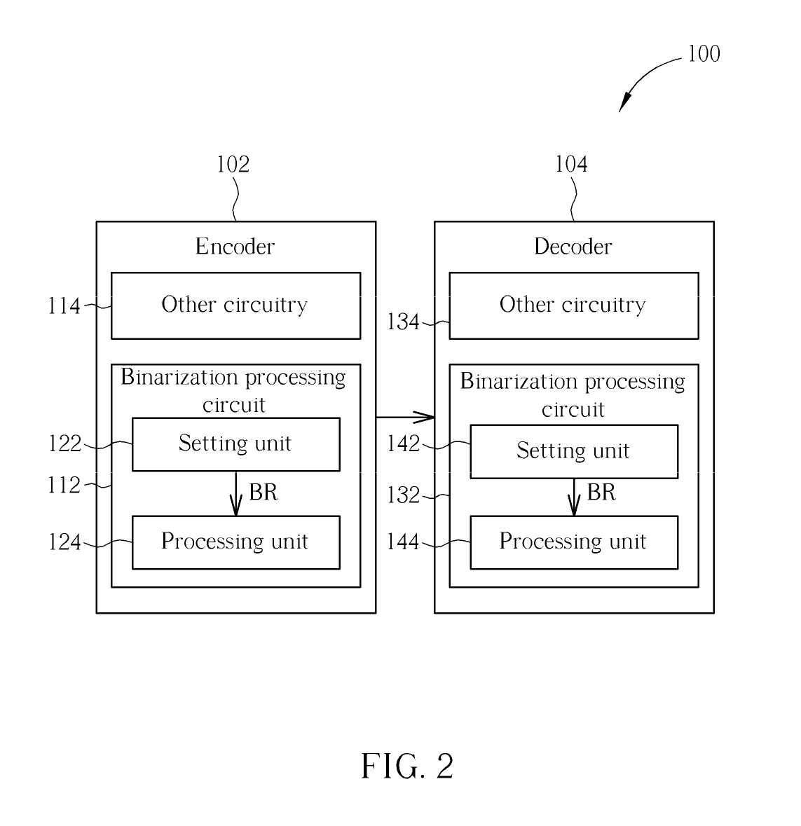

Please refer to FIG. 2, which is a diagram illustrating a coding system according to a first exemplary embodiment of the present invention. The coding system 100 includes an encoder 102 and a decoder 104. Regarding the encoder 102, it includes a binarization processing circuit 112 and other circuitry 114, wherein other circuitry 114 may include any needed circuit components needed for making the encoder 102 correctly perform its intended functionality, and the binarization processing circuit 112 includes a setting unit 122 and a processing unit 124. Regarding the decoder 104, it includes a binarization processing circuit 132 and other circuitry 134, wherein other circuitry 134 may include any circuit components needed for making the decoder 104 correctly perform its intended functionality, and the binarization processing circuit 132 includes a setting unit 142 and a processing unit 144. The setting unit 122/142 is arranged to provide a binarization rule BR which defines a plurality of binarization codewords (i.e., bin strings) mapped to a plurality of syntax elements for different motion partitions, respectively, wherein a codeword length of a binarization codeword corresponding to any square inter-prediction motion partition is shorter than a codeword length of a binarization codeword corresponding to any non-square inter-prediction motion partition. The processing unit 124/144 is coupled to the setting unit 122/142, and implemented for identifying mapping between a target binarization codeword and a target syntax element of a target motion partition according to the binarization rule BR. By way of example, but not limitation, the syntax element mentioned above is a macroblock type (or called CU mode/PU mode). Therefore, the binarization processing circuit 112 of the encoder 102 is responsible for performing binarization upon a macroblock type (i.e., CU mode/PU mode) by outputting a codeword/bin string according to the binarization rule BR, and the binarization processing circuit 132 of the decoder 104 is responsible for performing de-binarization upon a received codeword/bin string by outputting a macroblock type (i.e., CU mode/PU mode) according to the binarization rule BR. In general, the binarization rule BR referenced by the processing unit 144 in the decoder 104 is identical to the binarization rule BR referenced by the processing unit 124 in the encoder 102.

Moreover, it is possible that the occurrence probability of a larger square inter-prediction motion partition may be higher than that of a smaller square inter-prediction motion partition. Specifically, in a case where a partition size of a first square inter-prediction motion partition is larger than a partition size of a second square inter-prediction motion partition, a codeword length of a binarization codeword corresponding to the first square inter-prediction motion partition is defined to be shorter than a codeword length of a binarization codeword corresponding to the second square inter-prediction motion partition. That is, compared with a smaller square inter-prediction motion partition, a larger square inter-prediction motion partition may be assigned with a shorter codeword for better coding efficiency. However, this is for illustrative purposes only, and is not meant to be a limitation to the present invention. In other words, the spirit of the present invention is obeyed as long as codewords of square inter-prediction motion partitions (e.g., inter-prediction CUs/PUs) are shorter than those of rectangular inter-prediction motion partitions (e.g., rectangular inter-prediction PUs).

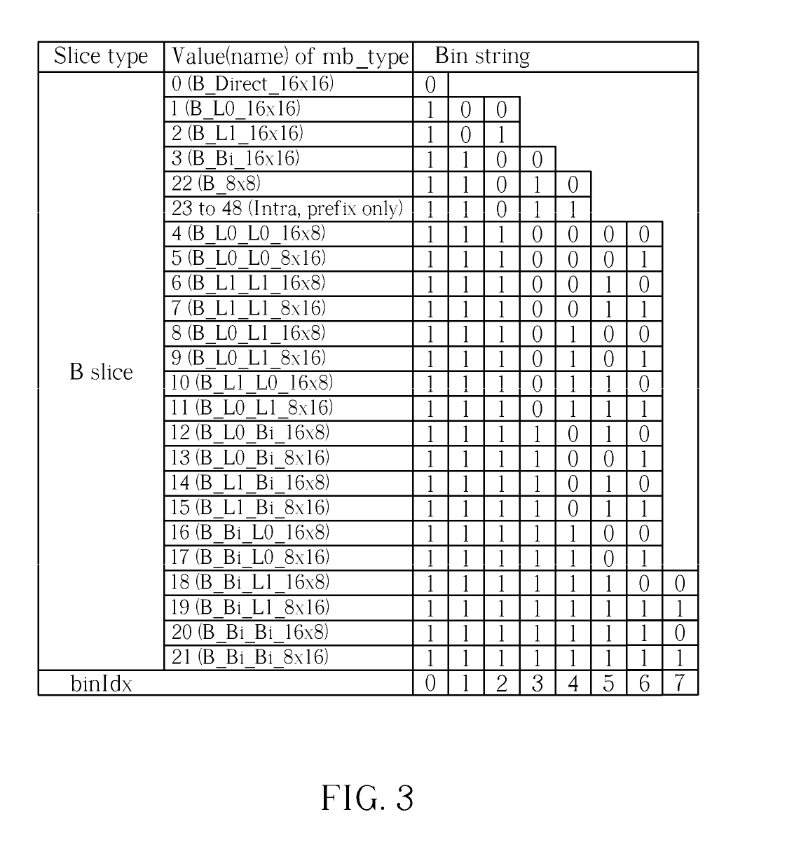

The aforementioned binarization rule BR may be represented using a binarization table. Please refer to FIG. 3, which is a diagram illustrating an exemplary embodiment of a modified binarization table of mb_type for a 16×16 motion partition (i.e., CU=16×16) according to the present invention. As mentioned above, a codeword length of a binarization codeword corresponding to any square inter-prediction motion partition is shorter than a codeword length of a binarization codeword corresponding to any non-square inter-prediction motion partition. Thus, as shown in FIG. 3, the square inter-prediction motion partition B_Direct_{—}16×16, indexed by 0, is assigned with a codeword “0” having a codeword length equal to 1; the square inter-prediction motion partition B_L0_{—}16×16, indexed by 1, is assigned with a codeword “100” having a codeword length equal to 3; the square inter-prediction motion partition B_L1_{—}16×16, indexed by 2, is assigned with a codeword “100” having a codeword length equal to 3; the square inter-prediction motion partition B_Bi16×16, indexed by 3, is assigned with a codeword “1100” having a codeword length equal to 4; and the square inter-prediction motion partition B_{—}8×8, indexed by 22, is assigned with a codeword “11010” having a codeword length equal to 5. Regarding the rectangular (non-square) inter-prediction motion partitions indexed by 4-21 respectively, the shortest codeword length is equal to 7 which is greater than the maximum value (i.e., 5) among codeword lengths of the square inter-prediction motion partitions.

As shown in FIG. 3, a codeword length of a prefix binarization codeword corresponding to any intra-prediction motion partition is also shorter than a codeword length of a binarization codeword corresponding to any non-square inter-prediction motion partition. That is, intra-prediction motion partitions, indexed by 23-48, are assigned with a prefix codeword “11011” having a codeword length equal to 5. However, this is for illustrative purposes only, and is not meant to be a limitation to the present invention. In other words, the spirit of the present invention is obeyed as long as codewords of square inter-prediction motion partitions (e.g., inter-prediction CUs/PUs) are shorter than those of rectangular inter-prediction motion partitions (e.g., rectangular inter-prediction PUs).

It should be noted that a modified binarization table of mb_type for a 32×32 motion partition (i.e., CU=32×32) and a modified binarization table of mb_type for a 64×64 motion partition (i.e., CU=64×64) may be configured in a similar way used for configuring the modified binarization table of mb_type for the 16×16 motion partition (i.e., CU=16×16). Further description is therefore omitted here for brevity.

Briefly summarized, as the square inter-prediction motion partitions (e.g., square inter-prediction CUs/PUs) with higher occurrence probabilities than rectangular (non-square) inter-prediction motion partitions (e.g., rectangular inter-prediction PUs) are assigned with shorter codewords, an experimental result clearly shows that better coding performance can be achieved.

In one exemplary implementation, the binarization rule BR provided by the setting unit 122/142 may has a fixed order of codewords. However, in another exemplary implementation, the binarization rule BR provided by the setting unit 122/142 may has an adaptive order of codewords. That is, the binarization rule BR may be adaptively adjusted according to statistics. For example, after the mapping between the target binarization codeword and the target syntax element of the target motion partition is identified, the setting unit 122/142 obtains statistics of occurrence probabilities of the different motion partitions and updates the binarization rule BR according to the statistics. Suppose that a codeword length of an initial codeword assigned to a first motion partition is longer than a codeword length of an initial codeword assigned to a second motion partition. When the occurrence probability of the first motion partition is higher than the occurrence probability of the second motion partition after several CUs have been processed, the first motion partition may be assigned a new codeword with a shorter codeword length, whereas the second motion partition may be assigned a new codeword with a longer codeword length.

Please note that the setting unit 122 may be configured to switch the binarization rule BR between a fixed order and an adaptive order. In one exemplary implementation, when the setting unit 122 controls the binarization rule BR to switch between the fixed order and the adaptive order, a flag may also be transmitted from the encoder 102 to the decoder 104 to notify the setting unit 142 of the decoder 104. Thus, as the setting unit 142 can correctly control the binarization rule BR to switch between a fixed order and an adaptive order at the decoder 104 under the notification of the received flag, the de-binarization performed by the processing unit 144 in the decoder 104 can work normally and correctly.

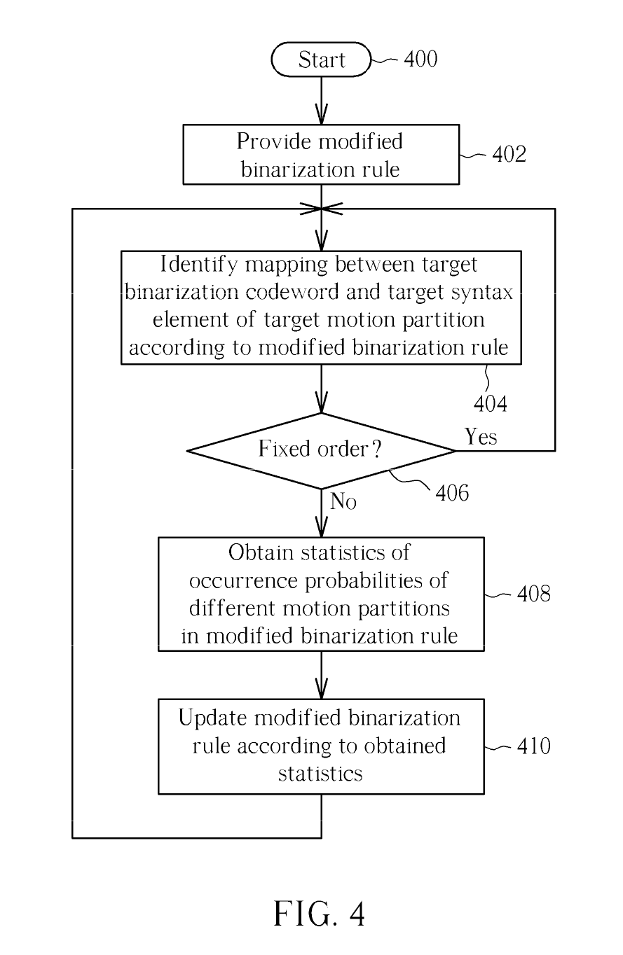

FIG. 4 is a flowchart illustrating a method for processing a target motion partition in a tree-based motion compensation according to a first exemplary embodiment of the present invention. Provided that the result is substantially the same, the steps are not limited to be executed in the exact order shown in FIG. 4. The exemplary method may be performed by the binarization processing circuit 112/114 shown in FIG. 2, and may be briefly summarized as follows.

Step 400: Start.

Step 402: Provide a binarization rule which defines a plurality of binarization codewords (i.e., bin strings) mapped to a plurality of syntax elements (e.g., macroblock types, CU modes or PU modes) for different motion partitions (e.g., CUs/PUs), respectively, wherein a codeword length of a binarization codeword corresponding to any square inter-prediction motion partition is shorter than a codeword length of a binarization codeword corresponding to any non-square inter-prediction motion partition.

Step 404: Perform binarization/de-binarization by identifying mapping between a target binarization codeword and a target syntax element of a target motion partition according to the binarization rule.

Step 406: Is the order in the binarization rule fixed? If yes, go to step 404 to keep processing a next target motion partition; otherwise, go to step 408.

Step 408: Obtain statistics of occurrence probabilities of the different motion partitions in the binarization rule.

Step 410: Update the binarization rule according to the statistics. Go to step 404 to keep processing a next target motion partition.

In the flow shown in FIG. 4, step 410 may be executed for updating the binarization rule each time the processing of one PU is accomplished. However, this is for illustrative purposes only. Alternatively, step 410 may be executed for updating the binarization rule only when the processing of one CU is accomplished. That is, suppose that a target motion partition is the last PU in one CU to be processed. After the mapping between the target binarization codeword and the target syntax element of the target motion partition is identified for binarization/de-binarization (step 404), the setting unit 122/142 obtains statistics of occurrence probabilities of the different motion partitions and then updates the binarization rule according to the statistics (steps 408 and 410). This also obeys the spirit of the present invention and falls within the scope of the present invention.

As a person skilled in the art can readily understand operations of the steps in FIG. 4 after reading above paragraphs, further description is omitted here for brevity.

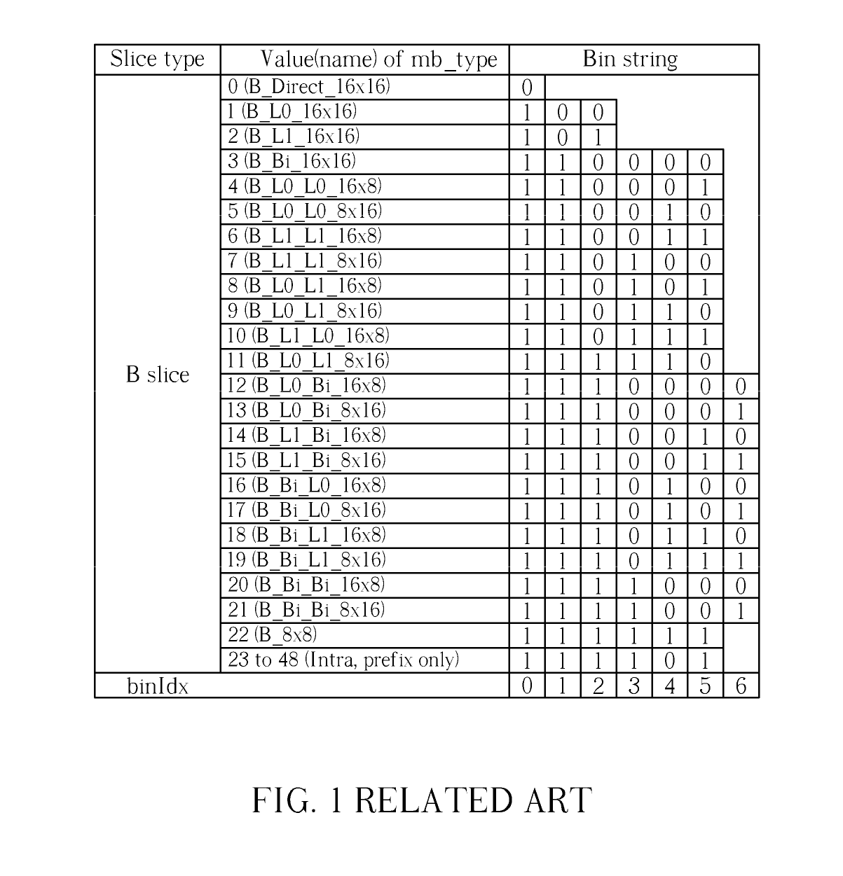

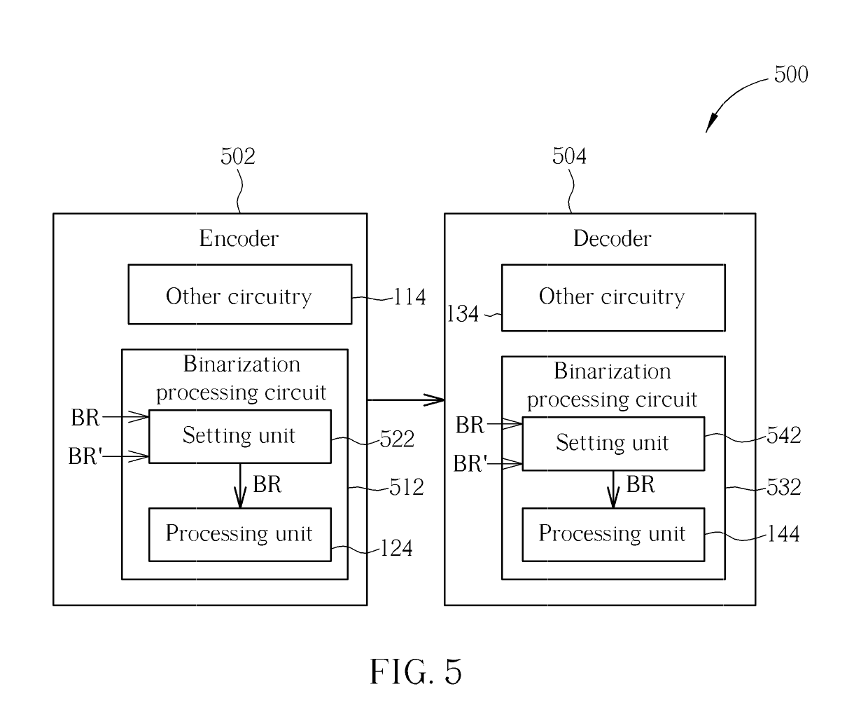

To achieve optimized coding performance and/or improve the flexibility, the binarization processing circuit may be configured to selectively employ the conventional binarization rule or the aforementioned modified binarization rule according to what is actually needed. Please refer to FIG. 5, which is a diagram illustrating a coding system according to a second exemplary embodiment of the present invention. The hardware configuration of the coding system 500 shown in FIG. 5 is similar to that of the coding system 100 shown in FIG. 2. The major difference is the setting unit 522/542 included in the binarization processing circuit 512/532 of the encoder 502/decoder 504. In this alternative design, the setting unit 522/542 selects a target binarization rule BR_T from a first binarization rule BR and a second binarization rule BR′. The first binarization rule BR defines a plurality of first binarization codewords (i.e., bin strings) mapped to a plurality of syntax elements (e.g., macroblock types, CU modes or PU modes) for different first motion partitions, respectively, and a codeword length of a first binarization codeword corresponding to any square inter-prediction motion partition is shorter than a codeword length of a first binarization codeword corresponding to any non-square inter-prediction motion partition. The second binarization rule BR′ defines a plurality of second binarization codewords (i.e., bin strings) mapped to a plurality of syntax elements (e.g., macroblock types, CU modes or PU modes) for different second motion partitions, respectively, and a codeword length of a second binarization codeword corresponding to a square inter-prediction motion partition is longer than a codeword length of a second binarization codeword corresponding to a non-square inter-prediction motion partition. For example, the first binarization rule BR may have the order of codewords shown in the exemplary binarization table of FIG. 3, while the second binarization rule BR may have the order of codewords shown in the exemplary binarization table of FIG. 1. That is, in this exemplary embodiment, the second binarization rule BR′ is a conventional binarization rule, and the first binarization rule BR is a modified binarization rule proposed in the present invention.

The processing unit 124/144 is arranged to identify mapping between a target binarization codeword and a target syntax element (e.g., a target macroblock type, CU mode or PU mode) of a target motion partition according to the target binarization rule BR_T. By way of example, but not limitation, the setting unit 522/542 is arranged to determine the target binarization table BR_T at a sequence level, a GOP (group of pictures) level, a picture level, or a slice level. In other words, the use of the modified binarization rule BR is enabled or disabled at the sequence level, the GOP level, the picture level, or the slice level. In addition, when the setting unit 522 changes the selection of the target binarization rule BR_T, a flag may also be transmitted from the encoder 502 to the decoder 504 to notify the setting unit 542 of the decoder 504. Thus, as the setting unit 542 can correctly change the selection of the target binarization rule BR_T under the notification of the received flag, the de-binarization performed by the processing unit 144 in the decoder 504 can work normally and correctly.

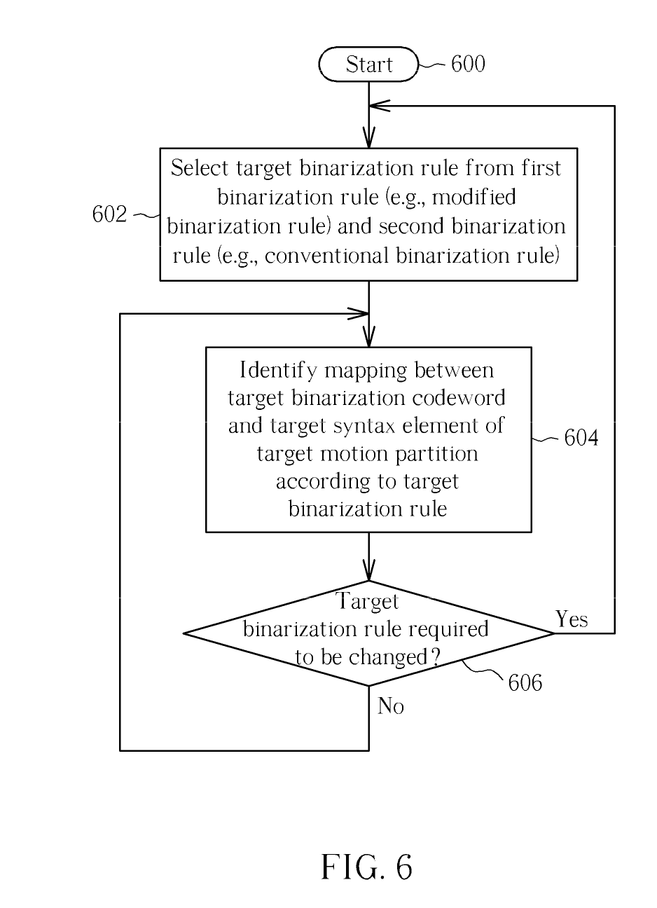

FIG. 6 is a flowchart illustrating a method for processing a target motion partition in a tree-based motion compensation according to a second exemplary embodiment of the present invention. Provided that the result is substantially the same, the steps are not limited to be executed in the exact order shown in FIG. 6. The exemplary method may be performed by the binarization processing circuit 512/514 shown in FIG. 5, and may be briefly summarized as follows.

Step 600: Start.

Step 602: Select a target binarization rule from a first binarization rule (e.g., a modified binarization rule proposed in the present invention) and a second binarization rule (e.g., a conventional binarization rule).

Step 604: Perform binarization/de-binarization by identifying mapping between a target binarization codeword and a target syntax element (e.g., a target macroblock type, CU mode or PU mode) of a target motion partition according to the target binarization rule.

Step 606: Is the current target binarization rule required to be changed at a sequence level, a GOP level, a picture level, or a slice level? If yes, go to step 602; otherwise, go to step 604 to keep processing a next target motion partition.

As a person skilled in the art can readily understand operations of the steps in FIG. 6 after reading above paragraphs, further description is omitted here for brevity.

It should be noted that when the setting unit 522 enables the first binarization rule BR as the target binarization rule BR_T, the target binarization rule BR_T may have a fixed order or may be adaptively updated according to the statistics of occurrence probabilities of different motion partitions.

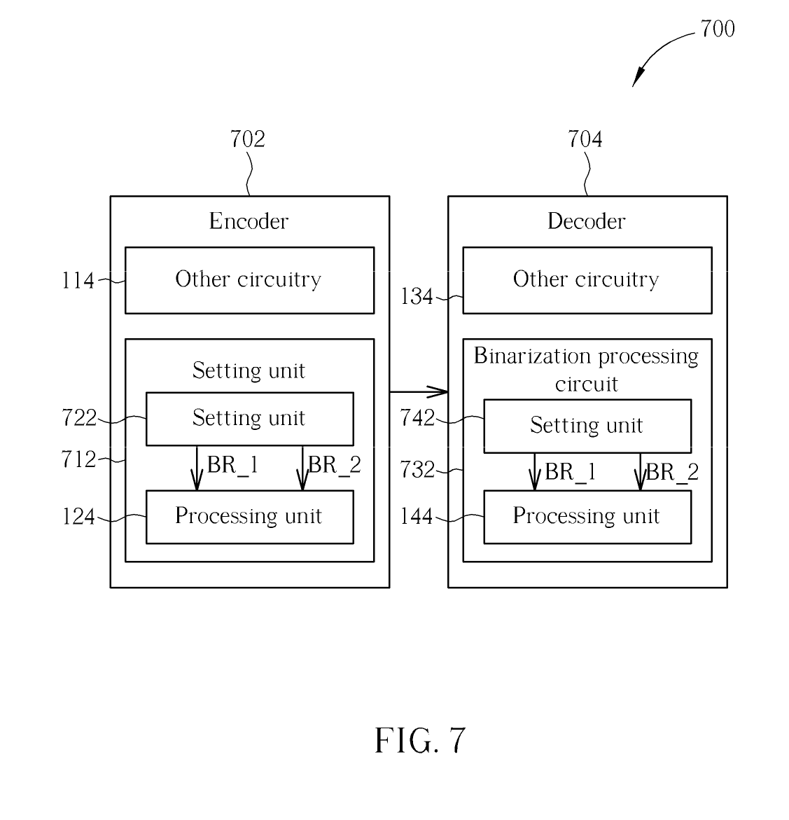

To achieve optimized coding performance and/or improve the flexibility, the binarization processing circuit may be configured to employ different modified binarization rules for different target motion partitions at different CU levels. For example, when the CU size is 64×64, the modified binarization rule employed by the encoder/decoder may have a first order of codewords for the square and rectangular inter-prediction motion partitions, and when the CU size is 32×32, the modified binarization rule employed by the encoder/decoder may have a second order of codewords for the square and rectangular inter-prediction motion partitions. Please refer to FIG. 7, which is a diagram illustrating a coding system according to a third exemplary embodiment of the present invention. The hardware configuration of the coding system 700 shown in FIG. 7 is similar to that of the coding system 100 shown in FIG. 2. The major difference is the setting unit 722/742 included in the binarization processing circuit 712/732 of the encoder 702/decoder 704. In this alternative design, the setting unit 722/742 provides different binarization rules including, for example, a first binarization rule BR_1 and a second binarization rule BR_2. The first binarization rule BR_1 defines a plurality of first binarization codewords (i.e., bin strings) mapped to a plurality of syntax elements (e.g., macroblock types, CU modes or PU modes) for different first motion partitions, respectively, and the second binarization rule BR_2 defines a plurality of second binarization codewords (i.e., bin strings) mapped to a plurality of syntax elements (e.g., macroblock types, CU modes or PU modes) for different second motion partitions, respectively. The processing unit 124/144 performs binarization/de-binarization by identifying mapping between a target binarization codeword and a target syntax element of a first target motion partition according to the first binarization rule BR_1 and identifying mapping between a target binarization codeword and a target syntax element of a second target motion partition according to the second binarization rule BR_2.

In this exemplary embodiment, each of the first binarization rule BR_1 and the second binarization rule BR_2 is a modified binarization rule proposed in the present invention. That is, regarding the first binarization rule BR_1, a codeword length of a first binarization codeword corresponding to any square inter-prediction motion partition is shorter than a codeword length of a first binarization codeword corresponding to any non-square inter-prediction motion partition; additionally, regarding the second binarization rule BR_2, a codeword length of a second binarization codeword corresponding to any square inter-prediction motion partition is shorter than a codeword length of a second binarization codeword corresponding to any non-square inter-prediction motion partition.

Moreover, each of the first binarization rule BR_1 and the second binarization rule BR_2 may have a fixed order or may be adaptively updated according to the statistics of occurrence probabilities of different motion partitions. In a case where the adaptive order is used, after the mapping between the target binarization codeword and the target syntax element of the first target motion partition is identified, the setting unit 722/742 obtains statistics of occurrence probabilities of the different first motion partitions in the first binarization rule BR_1 and updates the first binarization rule BRI according to the statistics of occurrence probabilities of the different first motion partitions; similarly, after the mapping between the target binarization codeword and the target syntax element of the second target motion partition is identified, the setting unit 722/742 obtains statistics of occurrence probabilities of the different second motion partitions in the second binarization rule BR_2 and updates the second binarization rule BR_2 according to the statistics of occurrence probabilities of the different second motion partitions.

Please note that the setting unit 722 may switch the first binarization rule BR_1/second binarization rule BR_2 between a fixed order and an adaptive order. In this exemplary embodiment, when the setting unit 722 controls the first binarization rule BR_1/second binarization rule BR_2 to switch between the fixed order and the adaptive order, a flag may also be transmitted from the encoder 702 to the decoder 704 to notify the setting unit 742 of the decoder 704. Thus, as the setting unit 742 can correctly control the first binarization rule BR_1/second binarization rule BR_2 to switch between a fixed order and an adaptive order under the notification of the received flag, the de-binarization performed by the processing unit 144 in the decoder 704 can work normally and correctly.

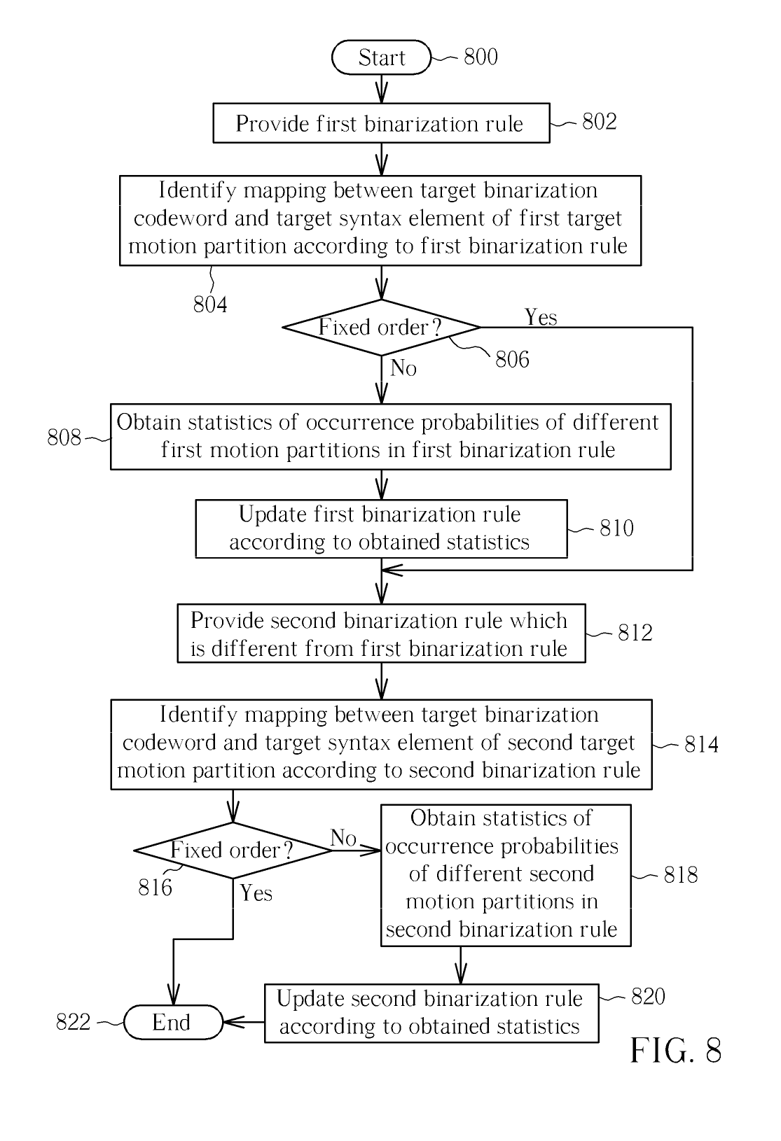

FIG. 8 is a flowchart illustrating a method for processing a target motion partition in a tree-based motion compensation according to a third exemplary embodiment of the present invention. Provided that the result is substantially the same, the steps are not limited to be executed in the exact order shown in FIG. 8. The exemplary method may be performed by the binarization processing circuit 712/714 shown in FIG. 7, and may be briefly summarized as follows.

Step 800: Start.

Step 802: Provide a first binarization rule which defines a plurality of first binarization codewords (i.e., bin strings) mapped to a plurality of syntax elements (e.g., macroblock types, CU modes or PU modes) for different first motion partitions, respectively. In one exemplary implementation, a codeword length of a first binarization codeword corresponding to any square inter-prediction motion partition is shorter than a codeword length of a first binarization codeword corresponding to any non-square inter-prediction motion partition.

Step 804: Perform binarization/de-binarization by identifying mapping between a target binarization codeword and a target syntax element of a first target motion partition according to the first binarization rule.

Step 806: Is the order in the first binarization rule fixed? If yes, go to step 812 to keep processing a second target motion partition; otherwise, go to step 808.

Step 808: Obtain statistics of occurrence probabilities of the different first motion partitions in the first binarization rule.

Step 810: Update the first binarization rule according to the statistics obtained in step 808.

Step 812: Provide a second binarization rule which defines a plurality of second binarization codewords (i.e., bin strings) mapped to a plurality of syntax elements (e.g., macroblock types, CU modes or PU modes) for different second motion partitions, respectively. In one exemplary implementation, a codeword length of a second binarization codeword corresponding to any square inter-prediction motion partition is shorter than a codeword length of a second binarization codeword corresponding to any non-square inter-prediction motion partition.

Step 814: Perform binarization/de-binarization by identifying mapping between a target binarization codeword and a target syntax element of the second target motion partition according to the second binarization rule which is different from the first binarization rule.

Step 816: Is the order in the second binarization rule fixed? If yes, go to step 822; otherwise, go to step 818.

Step 818: Obtain statistics of occurrence probabilities of the different second motion partitions in the second binarization rule.

Step 820: Update the second binarization rule according to the statistics obtained in step 818.

Step 822: End.

In the flow shown in FIG. 8, steps 810 and 820 are executed for updating the first binarization rule and the second binarization rule each time the processing of one PU is accomplished. However, this is for illustrative purposes only. Alternatively, steps 810 and 820 may be executed for updating the first binarization rule and the second binarization only when the processing of one CU is accomplished. That is, suppose that the first target motion partition is the last PU in one CU to be processed, and the second target motion partition is the last PU in another CU to be processed. After the mapping between the target binarization codeword and the target syntax element of the first target motion partition is identified for binarization/de-binarization (step 804), the setting unit 722/742 obtains statistics and then updates the first binarization rule BR_1 according to the statistics (steps 808 and 810); additionally, after the mapping between the target binarization codeword and the target syntax element of the second target motion partition is identified for binarization/de-binarization (step 814), the setting unit 722/742 obtains statistics and then updates the second binarization rule BR_2 according to the statistics (steps 818 and 820).

As a person skilled in the art can readily understand operations of the steps in FIG. 8 after reading above paragraphs, further description is omitted here for brevity.

It should be noted that the above-mentioned exemplary methods and binarization processing circuits may be employed in a tree-based motion compensation in H.264, extended MB proposal, H.265/HEVC TMuC, or other coding standard. These all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing a target motion partition in a tree-based motion compensation, comprising:
utilizing a setting unit for providing a first binarization rule which defines a plurality of binarization codewords mapped to a plurality of syntax elements for different motion partitions, respectively, wherein a codeword length of a binarization codeword corresponding to any square inter-prediction motion partition is shorter than a codeword length of a binarization codeword corresponding to any non-square inter-prediction motion partition; and
identifying mapping between a target binarization codeword and a target syntax element of the target motion partition according to the first binarization rule.

2. The method of claim 1, wherein each syntax element is a macroblock type.

3. The method of claim 1, wherein a partition size of a first square inter-prediction motion partition is larger than a partition size of a second square inter-prediction motion partition, and a codeword length of a binarization codeword corresponding to the first square inter-prediction motion partition is shorter than a codeword length of a binarization codeword corresponding to the second square inter-prediction motion partition.

4. The method of claim 1, further comprising:
after the mapping between the target binarization codeword and the target syntax element of the target motion partition is identified, obtaining statistics of occurrence probabilities of the different motion partitions and updating the first binarization rule according to the statistics.

5. The method of claim 1, wherein a codeword length of a prefix binarization codeword corresponding to any intra-prediction motion partition is shorter than the codeword length of the binarization codeword corresponding to any non-square inter-prediction motion partition.

6. The method of claim 1, further comprising:
selecting a target binarization rule from the first binarization rule and a second binarization rule, wherein the second binarization rule defines a plurality of second binarization codewords mapped to a plurality of syntax elements for different second motion partitions, respectively; and identifying mapping between the target binarization codeword and the target syntax element of the target motion partition according to the first binarization rule when the target binarization rule is selected as the first binarization rule; and identifying mapping between the target binarization codeword and the target syntax element of the target motion partition according to the second binarization rule when the target binarization rule is selected as the second binarization rule.

7. The method of claim 6, wherein a codeword length of a second binarization codeword corresponding to a square inter-prediction motion partition is longer than a codeword length of a second binarization codeword corresponding to a non-square inter-prediction motion partition.

8. The method of claim 6, wherein the target binarization rule is determined at a sequence level, a GOP (group of pictures) level, a picture level, or a slice level.

9. The method of claim 1 further comprises processing a second target motion partition, comprising:
utilizing the setting unit for providing a second binarization rule which defines a plurality of second binarization codewords mapped to a plurality of syntax elements for different second motion partitions, respectively, wherein the first binarization rule is different from the second binarization rule, and the first binarization rule and the second binarization rule correspond to different coding unit levels; and
identifying mapping between a target binarization codeword and a target syntax element of the second target motion partition according to the second binarization rule.

10. The method of claim 9, wherein a codeword length of a first binarization codeword corresponding to any square inter-prediction motion partition is shorter than a codeword length of a first binarization codeword corresponding to any non-square inter-prediction motion partition, and a codeword length of a second binarization codeword corresponding to any square inter-prediction motion partition is shorter than a codeword length of a second binarization codeword corresponding to any non-square inter-prediction motion partition.

11. The method of claim 9, further comprising:
after the mapping between the target binarization codeword and the target syntax element of the second target motion partition is identified, obtaining statistics of occurrence probabilities of the different second motion partitions and updating the second binarization rule according to the statistics of occurrence probabilities of the different second motion partitions.

12. A binarization processing circuit for processing a target motion partition in a tree-based motion compensation, comprising:
a setting unit, arranged to provide a first binarization rule which defines a plurality of binarization codewords mapped to a plurality of syntax elements for different motion partitions, respectively, wherein a codeword length of a binarization codeword corresponding to any square inter-prediction motion partition is shorter than a codeword length of a binarization codeword corresponding to any non-square inter-prediction motion partition; and
a processing unit, coupled to the setting unit, for identifying mapping between a target binarization codeword and a target syntax element of the target motion partition according to the first binarization rule.

13. The binarization processing circuit of claim 12, wherein each syntax element is a macroblock type.

14. The binarization processing circuit of claim 12, wherein a partition size of a first square inter-prediction motion partition is larger than a partition size of a second square inter-prediction motion partition, and a codeword length of a binarization codeword corresponding to the first square inter-prediction motion partition is shorter than a codeword length of a binarization codeword corresponding to the second square inter-prediction motion partition.

15. The binarization processing circuit of claim 12, wherein after the mapping between the target binarization codeword and the target syntax element of the target motion partition is identified, the setting unit obtains statistics of occurrence probabilities of the different motion partitions and updates the first binarization rule according to the statistics.

16. The binarization processing circuit of claim 12, wherein a codeword length of a prefix binarization codeword corresponding to any intra-prediction motion partition is shorter than the codeword length of the binarization codeword corresponding to any non-square inter-prediction motion partition.

17. The binarization processing circuit of claim 12, wherein the setting unit arranged to select a target binarization rule from the first binarization rule and a second binarization rule, wherein the second binarization rule defines a plurality of second binarization codewords mapped to a plurality of syntax elements for different second motion partitions, respectively; and the processing unit identifies mapping between the target binarization codeword and the target syntax element of the target motion partition according to the first binarization rule when the target binarization rule is selected as the first binarization rule, and identifies mapping between the target binarization codeword and the target syntax element of the target motion partition according to the second binarization rule when the target binarization rule is selected as the second binarization rule.

18. The binarization processing circuit of claim 17, wherein the setting unit determines the target binarization rule at a sequence level, a GOP (group of pictures) level, a picture level, or a slice level.

19. The binarization processing circuit of claim 12, wherein the setting unit further arranged to provide a second binarization rule which defines a plurality of second binarization codewords mapped to a plurality of syntax elements for different second motion partitions, respectively, the first binarization rule is different from the second binarization rule, and the first binarization rule and the second binarization rule correspond to different coding unit levels; and the processing unit further identifies mapping between a target binarization codeword and a target syntax element of a second target motion partition according to the second binarization rule.

20. The binarization processing circuit of claim 19, wherein a codeword length of a second binarization codeword corresponding to any square inter-prediction motion partition is shorter than a codeword length of a second binarization codeword corresponding to any non-square inter-prediction motion partition.

21. The binarization processing circuit of claim 19, wherein after the mapping between the target binarization codeword and the target syntax element of the second target motion partition is identified, the setting unit obtains statistics of occurrence probabilities of the different second motion partitions and updating the second binarization rule according to the statistics of occurrence probabilities of the different second motion partitions.
